(19) United States
(12) Patent Application Publication
(10) Pub. No.: US 2016/0004694 A1
(43) Pub. Date: Jan. 7, 2016

(54) METHODS, SYSTEMS, AND DEVICES FOR MANAGING AND ACCESSING GRAPHICAL DATA FOR PHYSICAL FACILITIES

(71) Applicant: Samuel Cornaby, Garland, UT (US)

(72) Inventor: Samuel Cornaby, Garland, UT (US)

(21) Appl. No.: 14/755,054

(22) Filed: Jun. 30, 2015

Related U.S. Application Data
(60) Provisional application No. 62/019,744, filed on Jul. 1, 2014.

(51) Int. Cl. G06F 17/30; G06F 3/0484; G06F 3/0482

(52) U.S. Cl. CPC G06F 17/3028; G06F 3/0482; G06F 3/04842; G06F 17/30268

(57) ABSTRACT

A system for managing access to images files for physical facilities includes an access component and an interface component. The access component is configured to access a database linking a plurality of images corresponding to the physical facilities in a hierarchal tree. The database includes information indicating a location on a parent image corresponding to a child image. The interface component is configured to display a first image corresponding to one or more of a root node and a branch node of the hierarchical tree and to display one or more first image markers on the first image corresponding to one or more second images having a child relationship with the first image. The interface component is configured to receive input from a user indicating selection of a first marker and to display an image from the one or more second images corresponding to the selected first marker.

### RELATED APPLICATION

This application claims the benefit under 35 U.S.C. §119(e) of U.S. Provisional Application No. 62/019,744, filed Jul. 1, 2014, which is hereby incorporated by reference herein in its entirety.

### TECHNICAL FIELD

The present disclosure relates to storage, management, and an access interface for images and graphical data corresponding to physical facilities.

### BRIEF DESCRIPTION OF THE DRAWINGS

FIG. 1 is a schematic diagram of a system for accessing files consistent with embodiments disclosed herein.

FIG. 2 is a schematic diagram of an image management system consistent with embodiments disclosed herein.

FIG. 3 illustrates a screen shot of an interface consistent with embodiments disclosed herein.

FIG. 4 illustrates a screen shot of an interface consistent with embodiments disclosed herein.

FIG. 5 illustrates a screen shot of an interface consistent with embodiments disclosed herein.

FIG. 6 illustrates a screen shot of an interface consistent with embodiments disclosed herein.

FIG. 7 illustrates a screen shot of an interface consistent with embodiments disclosed herein.

FIG. 8 is a schematic flow chart diagram illustrating a method for browsing or locating graphical data consistent with embodiments disclosed herein.

FIG. 9 is a schematic flow chart diagram illustrating a method for editing links or relationships between graphical data files consistent with embodiments disclosed herein.

### DETAILED DESCRIPTION

Businesses and other organizations often have a large number of files that must be stored and/or managed for later access. These files may include photographs, technical drawings, computer aided design (CAD) files, technical specifications, or the like. For example, a factory may include a large amount of equipment to be maintained in operation to keep the factory running. Those running or operating the factory may use files for reference purposes in managing or maintaining the plant or factory. For example, the files may include a floor plan or layout of a campus of the factory and one or more buildings of the factory, schematics for machinery, and images or CAD files for subsystems or parts of the machinery. In even a modestly sized plant or factory, the number of files that need to be stored, managed, and/or selectively accessed can be quite large.

Generally, files or images are stored using a file system or database. Locating images in these systems can often involve searches, guess work, and in-depth knowledge of how a file system or database is organized. These methods of storage, access, and management can complicate the process for workers to locate files, part information, or other information needed to manage, repair, or maintain assets of an organization. For example, users may have a difficult time locating a file or an image and thereby may be delayed in fixing or maintaining machinery, ordering new parts, or the like. This can add time and monetary costs to the operation of an organization.

Based on the foregoing, applicants have developed methods, systems, and devices for visual access and management of files or visual data. For example, the methods, systems, and devices may be used to access an entirety of images or graphical files for an entity or physical facility. In one embodiment, the present application discloses a front end for browsing, accessing, and/or managing a large number of images. Some embodiments of facilities that may be managed include manufacturing or other plants, storage warehouses, shipping or routing warehouses, fulfillment centers, packaging factories, or any other facility that utilizes a large number of machinery or parts.

The present disclosure discusses embodiments and examples relating to managing and storing images and/or other visual data. However, these should be understood as given by way of example only, as the present systems, methods, and devices may be applied to a variety of files or information that may be visually displayed to users.

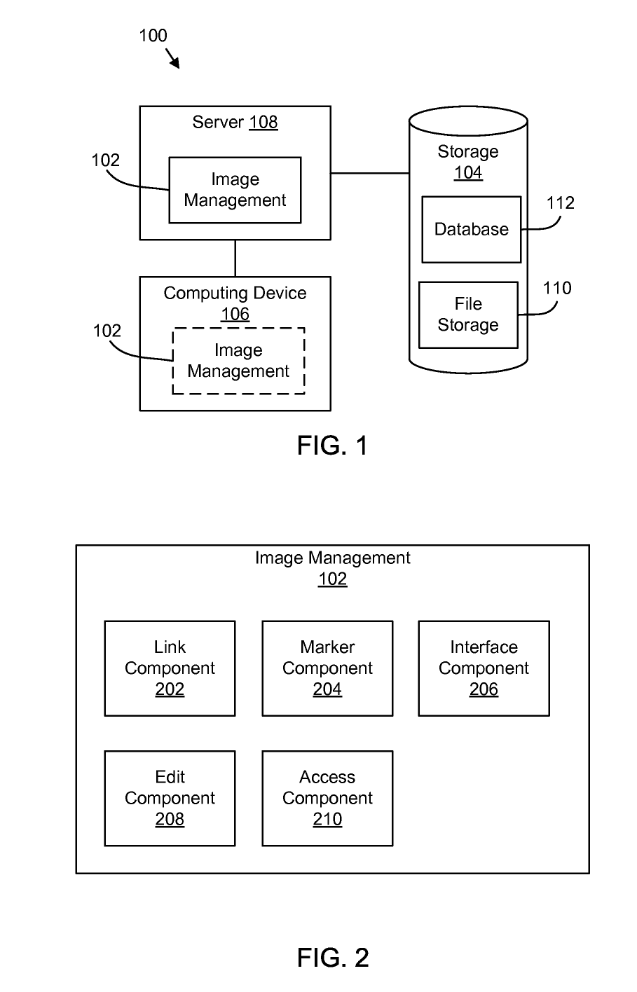

FIG. 1 illustrates one embodiment of a system 100 for storing, managing, and accessing files. The system 100 includes a server 108, an image management component 102, a storage 104, and a computing device 106. In one embodiment, the storage 104 includes a file storage 110 for storing files for an entity, such as image files, technical drawings, or other types of files or graphical data discussed herein. The files in the file storage 110 may be stored in a database, a file system, or another type of storage structure. The storage 104 may also store a database 112 that includes metadata about hierarchical relationships between files in the file storage 110 that form a hierarchical tree. In one embodiment, images or other files may be stored directly in the database 112. The server 108 may include a server or other computing device that includes code comprising an image management component 102. The image management component 102 may be embodied in code, circuitry, processor logic, or the like. The image management component 102 is used to organize and access the files stored by the storage 104 and/or a database indicating relationships between files. The computing device 106 may access the server 108 to obtain a portion of the image management component 102 as code to execute in order to browse, view, or otherwise access the files managed by the image management component 102. In one embodiment, the image management component 102, server 108, storage 104, and computing device 106 may be included within the same device or system. For example, a server, a desktop, or another computing device may include all of the components 102-112. In one embodiment, the computing device 106 may be a separate device that allows access to the files. For example, a plurality of computing devices 106 may allow multiple users to access and view the files managed by the server 108 and/or image management component 102 and stored by the storage 104. For example, the computing device 106 may include a browser to browse the images on a web interface provided by the image management component 102.

FIG. 2 is a block diagram illustrating components of one embodiment of an image management component 102. The image management component 102 includes a link component 202, a marker component 204, an interface component 206, an edit component 208, and an access component 210. The components 202-210 are given by way of example only and are not all included in all embodiments. In some embodiments, one or more of the components 202-210 may be distributed across two or more devices. For example, a server may include a link component 202 and a marker component 204 while a user device or computing system may include the interface component 206, the edit component 208, and the access component 210.

The link component 202 is configured to link a plurality of files together in a hierarchical tree. For example, the link component 202 may manage a metadata database (such as database 112) that stores information regarding relationships between the files. In one embodiment, the link component 202 stores information regarding child and/or parent relationships for each of the files or images. In one embodiment, the link component 202 may store link information for one or more of a root node, a branch node, or a leaf node of the hierarchical tree. For example, each node may include information about a corresponding file or image, such as a location or name of the file or an image in a file system or database. The link component 202 may also store information about a parent, a child, or another node that has a relationship with the file or image. For example, the information may include a location for the related image or file as well as the type of relationship (e.g., child, parent).

The hierarchical tree may have a depth of at least three nodes. For example, the hierarchical tree may have a root node, one or more branch nodes, and a leaf node. As used herein, the term root node is given to mean a node (or file) that has no parent relationships. For example, the root node may have no relationship with a node higher up, or with higher priority, in the hierarchical tree. As used herein, the term branch node is given to mean a node (or file) that has a parent and a child relationship. For example, the branch node may have relationships with nodes above and below the branch node in the tree. As used herein, the term leaf node is given to mean a node that has no child relationships. For example, the leaf node may have no children or relationships with nodes below the leaf node in the tree.

In an example, a root node may correspond to an overarching image or a file for an entity or a building or for a schematic layout or map of a campus. For example, the root node may correspond to a floor plan or map for a factory or plant. Branch nodes may correspond to regions, locations of departments, stations, or locations of machinery within the floor plan or map, and the leaf nodes may correspond to specific parts, machines, or systems within the corresponding regions, departments, or machinery. In one embodiment, the link component 202 may manage a hierarchical tree stored on a storage device, such as the database 112 and/or file storage 110 in the storage 104 of FIG. 1.

The marker component 204 determines a location within an image or a visual representation of a file to display a marker related to a related node. For example, the marker component 204 may determine a location on an image to display a marker corresponding to a node that has a child relationship with the currently displayed image or visual representation. The marker component 204 may determine the location by looking up the location within a metadata database, such as the metadata database managed by the link component 202. In one embodiment, the marker component 204 determines a location in an image file that corresponds to a related node. For example, the image may include a schematic of a machine, and a marker corresponding to a CAD file for a part of the machine may have a location in the schematic that corresponds to a location of the part within the machine. As another example, a file may include an image of a floor plan for a building, and the marker location may correspond to a location of a machine in the building. In one embodiment, the marker may be displayed on a visual representation of the file. A user may provide input to select the marker in order to view a file or node corresponding to the marker using a keyboard, mouse, touch screen, or other human-machine interface.

The interface component 206 may provide an interface for a user to view and/or browse a hierarchical tree or files within the hierarchical tree. For example, the interface may display an image with corresponding markers or other information. In one embodiment, the interface component 206 displays an image corresponding to a currently selected node on a display. For example, the interface component 206 may default to displaying an image corresponding to a root node. The interface component 206 may also display one or more markers on the image corresponding to related nodes, such as child nodes. In one embodiment, each marker has a corresponding x-y location on an image or visual representation of the file and/or a two-dimensional region (such as a box, circle, or other shape) covering a region of the image or visual representation. Thus, one familiar with a layout of a plant or building can identify markers based on the location. The markers corresponding to files may allow workers to use the system in an extremely intuitive manner because the workers see the layout, machines, and other physical facilities on a frequent basis. For example, little or no learning curve for identifying which marker corresponds to which machine, workstation, or the like may be required.

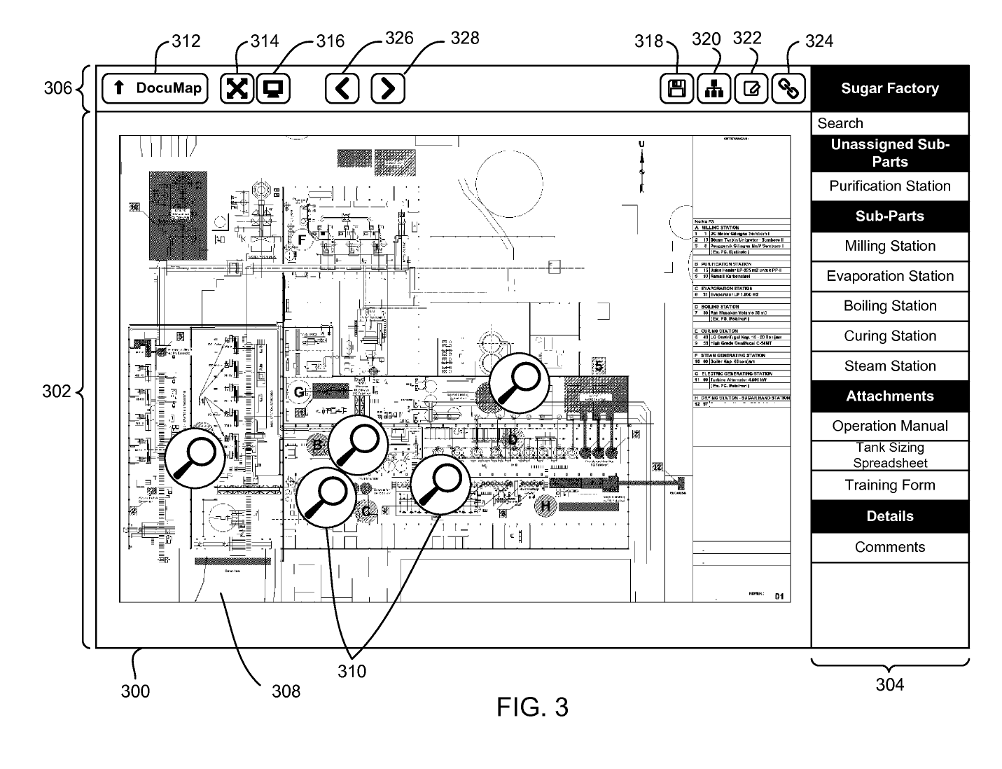

FIGS. 3-7 illustrate example embodiments of interfaces provided by the interface component 206. FIG. 3 illustrates a screen shot 300 of an interface for browsing or managing files or images. The interface includes a display region 302, a side bar 304, and an upper bar 306. In one embodiment, a user may be able to use the graphical elements of the interface to browse images or files of a hierarchical tree managed by the link component 202.

The display region 302 displays an image 308 corresponding to a currently selected file. For example, the file may include an image file, a CAD file, a PDF file, or another file that is rendered to produce the image 308. The image 308 includes a graphical representation of a floor plan of a factory. Specifically, the image 308 shown in FIG. 3 is an example image and corresponds to a floor plan for a sugar mill. The sugar mill includes a variety of regions and stations for performing different processing for producing sugar. Also displayed in the display region 302 are a plurality of markers 310. In one embodiment, each marker 310 corresponds to a child node, and an image, that has a child relationship with a current node corresponding to the displayed image 308. In one embodiment, the markers 310 may be selected (e.g., via an input device such as a mouse, a keyboard, a touch screen, or the like) to view an image corresponding to a selected marker. For example, a user may be able to select successive markers to “drill down” into a hierarchy of images below or above the floor plan image 308 to view more and more detail about regions, machinery, parts, or the like in the sugar mill (or whatever else is represented by the image 308).

The side bar 304 displays information regarding items displayed in the display region 302. The side bar 304 includes a general heading “Sugar Factory,” an “Unassigned Sub-Parts” heading, a “Sub-Parts” heading, an “Attachments” heading, and a “Details” heading. The “Sugar Factory” heading includes a name for the image 308 (i.e., the sugar factory). Under the “Sugar Factory” heading is a search field for a user to perform a text search. For example, the user may search for the name of a file, an image, a part, or the like. Under the “Sub-Parts” heading, a plurality of stations (“Milling Station,” “Evaporation Station,” “Boiling Station,” “Curing Station,” and “Steam Station”) are listed. Each of the sub-parts, specifically stations in this example, may correspond to a different region, set of machines or systems, or the like, of the sugar factory floor plan displayed in image 308. In one embodiment, each of the items under the “Sub-Parts” heading corresponds to one of the markers 310 in the display region 302. The labels under the “Unassigned Sub-Parts” heading may correspond to files or images that have yet to be assigned a region or location in the image 308. For example, they may already have an assigned parent-child relationship but may not yet have a location or marker corresponding to the file or image.

A user may drag a mouse over one of the items in the side bar 304, and a corresponding marker 310, or an item in the display region 302 may be highlighted or modified to indicate that the label corresponds to the specific marker 310. Similarly, dragging a mouse over the markers 310 may cause a corresponding label in the side bar 304 to be highlighted or otherwise indicate that the specific marker 310 corresponds to the label. For example, the interface component 206 may cause a sub-part to be highlighted in response to a mouse hover over a corresponding marker or may cause a marker to be highlighted in response to a mouse hover over a corresponding sub-part. In one embodiment, a region of the current image 308 may be shaded or highlighted to indicate a region of the image 308 to which a child node or marker 310 (include a corresponding image) corresponds. As discussed previously, a user may browse to another node (e.g., file or image) by selecting a marker 310. In one embodiment, the user may also select a label, corresponding to the marker 310 or node, to browse to the file or image. For example, a marker 310 may include an arrow pointing to a location on the image 308 and a label corresponding to the marker 310. The marker 310 may be selected, for example, by selecting the label.

Attached files are listed under the “Attachments” heading. In FIG. 3, the attached files include an operation manual, a tank sizing spreadsheet, and a training form. These attachments may include information, operation procedures, or other information pertinent to operation of the sugar factory or one or more machines, stations, etc. of the sugar factory. In one embodiment, any user can upload an attachment. In another embodiment, only users with edit rights are able to upload or attach files under the “Attachments” heading. Additional details, comments, links, or other text, numbers, or code can be entered, saved, and/or displayed under the “Details” heading. In one embodiment, a user without edit rights may be able to add comments but may not be able to modify other information in the side bar 304. A similar side bar may, in some embodiments, be available on any or all pages of any of the interfaces discussed herein or otherwise presented by the interface component 206.

The upper bar 306 includes a number of icons 312, 314, 316, 318, 320, 322, 324, 326, and 328 to navigate the hierarchical tree and/or interface. A first icon 312 may be used to move up a level or node of the hierarchical tree. For example, selection of the first icon 312 may cause the display region 302 to refresh with an image corresponding to a parent node of a currently selected node. As another example, the first icon 312 may cause the interface component 206 to refresh the interface to go to a home interface and/or a home or root node. A second icon 314 may be selected to cause a displayed image 308 to fill the display region 302 (e.g., fill a height and/or width of the display region 302). A third icon 316 may be selected to cause the image 308 to shrink to a size such that the full image 308 is viewable within the display region 302.

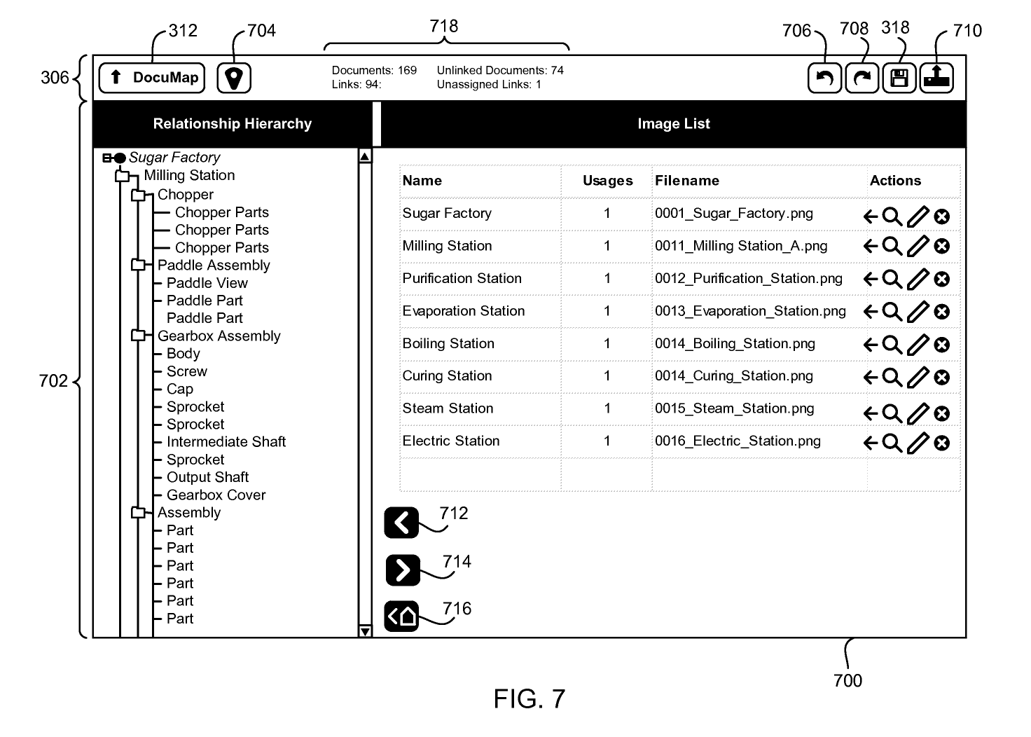

A fourth icon 318 may be selected to save changes or edits that have been entered or made by a user (as will be discussed in greater detail in relation to the edit component 208). The fifth icon 320 may switch a view to a relationship hierarchy view, as illustrated in FIG. 7. The relationship hierarchy view shows a branching or tree view of at least a portion of a hierarchical tree. A sixth icon 322 may be used to enter an edit mode to edit the hierarchical tree. For example, an option to select a region to assign to a specific image or file (i.e., indicate a location for a marker 310 for a file) may be provided, or an option to delete a region or document may be provided. Further discussion of editing a hierarchical tree will take place in relation to the editing component 208. A seventh icon 324 may be selected to selectively hide or show the side bar 304. An eighth icon 326 may be included to move to a previous view or previous image displayed in the display region 302. A ninth icon 328 may be included to move to a next view or subsequent image displayed in the display region 302. For example, the eighth icon 326 and ninth icon 328 may operate similarly to a forward or back button in a web browser.

The access component 210 allows the server and/or the computing device 106 to access information stored in storage 104. For example, the access component 210 provides access to the database 112 or file storage 110. In one embodiment, the access component 210 allows access over a network or local connection. In one embodiment, the access component 210 only allows access in response to user authentication.

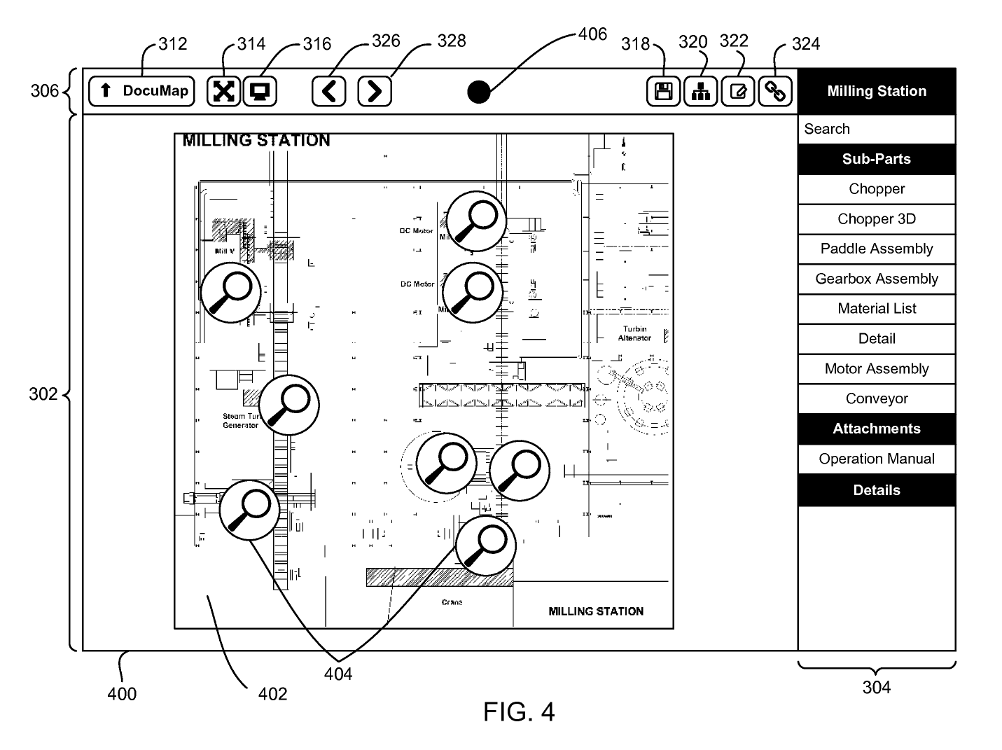

FIG. 4 illustrates a screen shot 400 of the interface of FIG. 3 in response to a user selecting one of the markers 310 or labels in the side bar 304. The interface shows a new image 402 that corresponds to the selected marker 310 or side bar label (or selected node). For example, the image 402 corresponds to the “Milling Station” label and/or associated marker 310. A plurality of markers 404 corresponding to child nodes of the image 402 are shown. The side bar 304 is updated showing labels for the markers 404. An icon 406 having a single dot is also shown to indicate a current hierarchical level of the current image 402. For example, the screen shot 300 of FIG. 3 does not include the icon 406 to reflect that the image 308 corresponds to a root node. The interface of FIG. 4 may include any of the icons 312-328, labels, or other items displayed in FIG. 3, according to one embodiment. For example, any of the features, notes, or other aspects of the side bar 304 may also be available in the interface of FIG. 4.

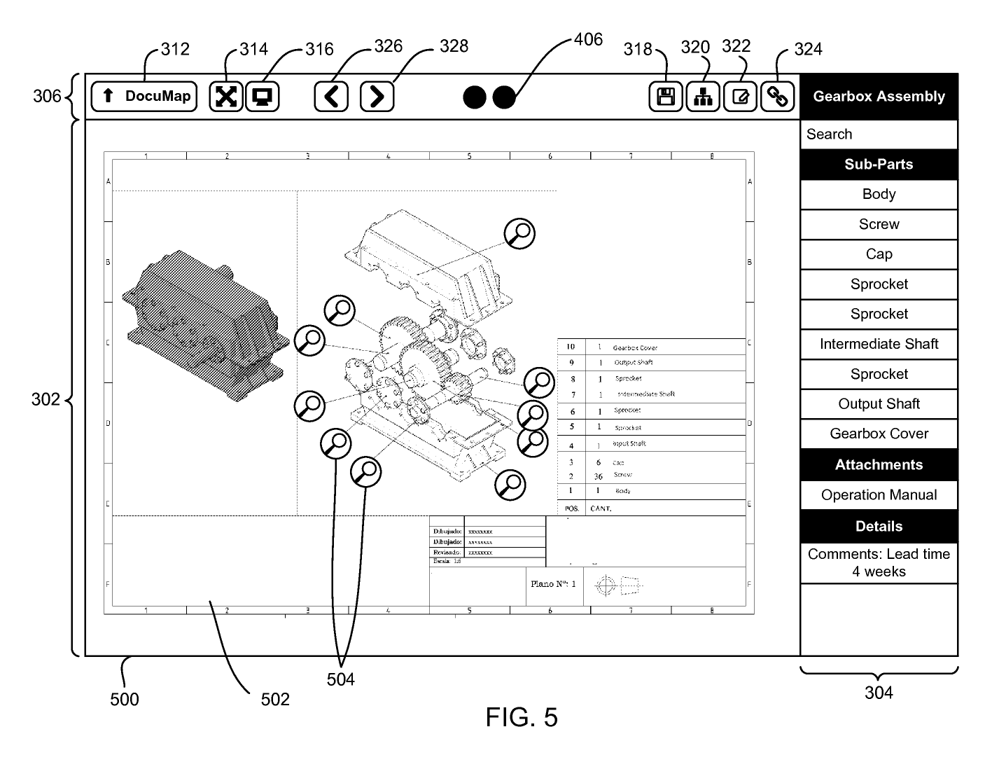

FIG. 5 illustrates a screen shot 500 of an interface in response to a user selecting one of the markers 404 or labels in the side bar 304 in FIG. 4, in one embodiment. The interface shows a new image 502 that corresponds to the selected marker 404 or side bar label (or selected node). For example, the image 502 corresponds to the “Gearbox Assembly” label and/or associated marker 404 of FIG. 4. A plurality of markers 504 corresponding to child nodes of the image 502 are shown. The side bar 304 is updated showing labels, attachments, and details for the image 502 and markers 504. The icon 406 is updated to include two dots to indicate a current hierarchical level of the current image 502. For example, the screen shot 400 of FIG. 4 includes the icon 406 having a single dot to reflect that the image 402 is one level below a root node. The current image 502, as indicated by the icon 406 with two dots, is two levels below (or away from or above, depending on terminology used) a root node.

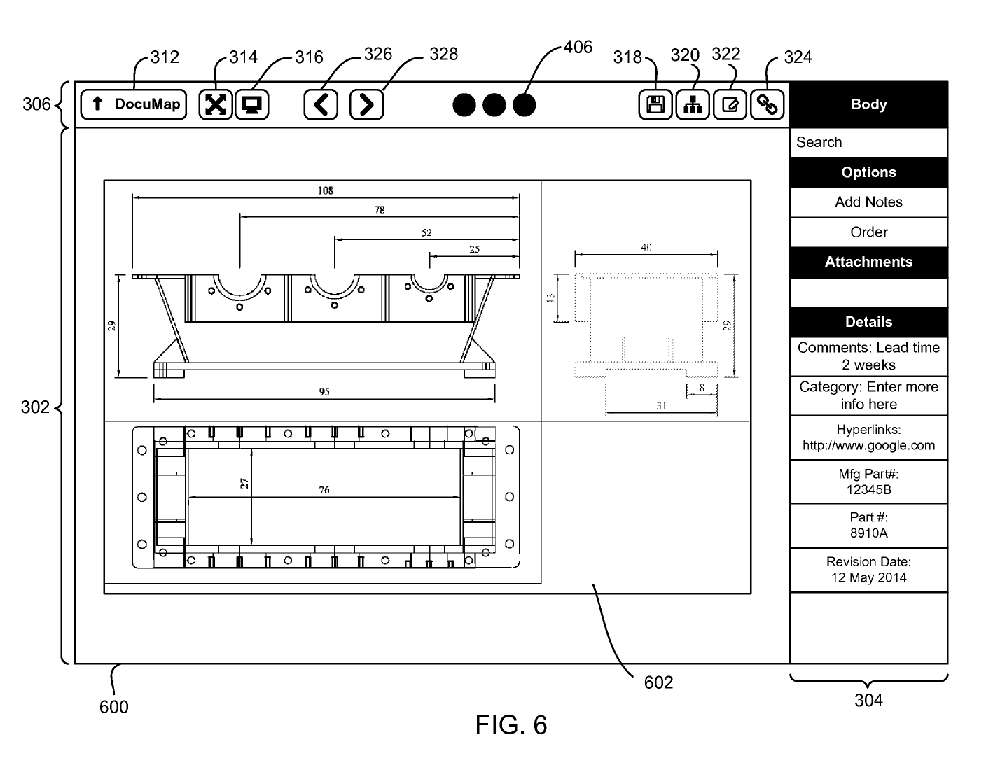

FIG. 6 illustrates a screen shot 600 of the interface of FIG. 5 in response to a user selecting one of the markers 504 in the display region 302 or labels in the side bar 304. The interface shows a new image 602 that corresponds to the selected marker 504 or side bar label (or selected node). For example, the image 602 corresponds to the “Body” label and/or associated marker 504 of FIG. 5. The display region 302 does not show any markers, as did the previous screen shots 300, 400, 500. For example, the image 602 corresponds to a leaf node and has no relationships with child nodes. Thus, no markers are shown to link to child nodes. The side bar 304 is updated to provide options for a user. For example, the side bar includes an “Add Notes” label which can be selected to add notes for the current image 602 or a product corresponding to the current image 602 or node. Any entered notes may appear under the “Details” heading. For example, a user may be able to add notes regarding lead time to order a part, a link to a manual, information regarding procedures (e.g., installation or repair procedures), a link to order spare parts, part numbers for a part, manufacturer codes, or the like. The side bar 304 also includes an “Order” label which may be selected to place an order for the part shown in the image 602 or to see information on how to order the part. The icon 406 is updated to include three dots to indicate a current hierarchical level of the current image 602. For example, the image 602, as indicated by the icon 406 with three dots, is three levels below, or away from, a root node (e.g., the image 308 in FIG. 3).

Returning to FIG. 2, the edit component 208 is configured to allow users to modify a hierarchical tree structure such as by adding nodes, deleting nodes, moving nodes, modifying or creating links or relationships, or otherwise modifying data or metadata for files. In one embodiment, a user may be required to provide authentication to indicate elevated privileges to enter an edit mode. For example, most users may not be allowed to edit the tree in order to limit error from entering into the tree. In one embodiment, a user, in edit mode, may be able to add files, remove files, and/or specify relationships between nodes (i.e., between files or images). In one embodiment, a user can highlight a region of an image, for example using a click and drag process, to specify where a marker should be positioned for a new or an existing node. The user may be able to select or upload a file or an image to be connected with the marker or image. In one embodiment, only markers corresponding to child nodes are shown on a currently displayed image when in an image or map view (such as the views illustrated in the interfaces of FIGS. 3-6).

In one embodiment, a user may enter a relationship hierarchy view to see a tree view of the hierarchical tree. FIG. 7 illustrates a screen shot 700 of one embodiment of a relationship hierarchy view. For example, the interface shown in FIG. 7 may result from a user selecting the fifth icon 320 of FIG. 3, 4, 5, or 6. A browsable hierarchical tree 702 is shown where a user can browse the tree, rename nodes, move nodes, delete nodes, or view the organization of the tree 702. In one embodiment, a user may be able to see the relationship hierarchy view but may not be able to provide edits unless or until authentication information is provided. In one embodiment, each node of the hierarchical tree 702 corresponds to an image or graphical file, such as the files illustrated in the image list. For example, a new node may be created each time an image is added to the tree, and relationships between the images may be created in a database each time a relationship between corresponding nodes is created.

The screen shot 700 showing the relationship hierarchy view is shown without the side bar 304 and includes new icons 704, 706, 708, and 710. A tenth icon 704 may be selected to return to an image view, such as that depicted in FIGS. 3-6. An eleventh icon 706 may be used to undo a change or an edit while a twelfth icon 708 may be used to redo or repeat a change or an edit. A thirteenth icon 710 may be used to perform a batch upload of files for inclusion in the tree 702. Additional icons in the relationship view may include an add icon 712, which may be clicked to add one or more files that are currently highlighted or selected in the image list as a child of a node highlighted or selected in the relationship hierarchy on the left. For example, a user with edit rights may select a node from the left, select one or more images from the image list, and then select the add icon 712 to add the one or more images as children of the selected node. When an image corresponding to the selected node is shown in the image or map view, the user may see the file names listed as “Unassigned Sub-Parts.” A remove icon 714 may be used to remove a file corresponding to a selected node from the relationship hierarchy. For example, selecting a node from the relationship hierarchy on the left and selecting the remove icon 714 may result in a removal of the node from the relationship hierarchy and deletion of a relationship with one or more parent or child notes in a metadata database. A root node icon 716 may be used to make a selected node or image a root node. For example, selection of a root node icon 716 may place a selected image or node in a root position of the tree 702 on the left. An information field 718 may be displayed that illustrates statistics about the number of documents, the number of links, the number of unlinked documents, and the number of unassigned links. For example, the number of documents may include the number of documents for which a metadata database is tracking relationships. The number of links may include the number of relationships between nodes or images. The number of unlinked documents may include the number of documents that have not been assigned any relationship with any other document. The number of unassigned links may include the number of links that have been created (e.g., as a relationship between to files) but for which no location in an image has been assigned. For example, an image may have a parent relationship with another file but may not yet have a specific location on the other file where a corresponding marker is to be displayed.

The interface of FIGS. 3-7 may provide for greater ease and speed in locating a desired file or data. In one embodiment, the interface may be particularly beneficial when browsing or locating images or other graphical data. A user may be able to locate a file without specific knowledge of a file storage system or database.

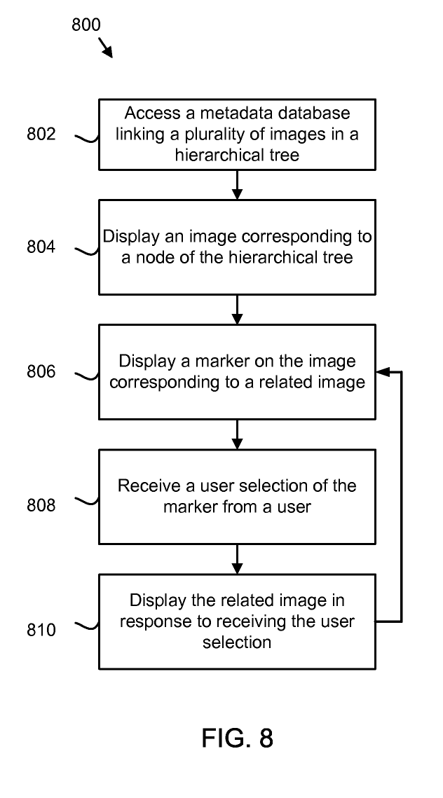

Turning to FIG. 8, a schematic flow chart diagram illustrating a method 800 for browsing files is illustrated. In one embodiment, the method 800 is performed by the image management component 102 of FIG. 2.

The method 800 begins and a link component 202 accesses 802 a metadata database linking a plurality of images in a hierarchical tree. The images correspond to root nodes, branch nodes, and/or leaf nodes of the hierarchical tree. An interface component 206 displays 804 an image corresponding to one or more of a root node and a branch node. A marker component 204 displays 806 a marker on the image corresponding to a related image. In one embodiment, the marker is positioned on the image corresponding to a location associated with the related image. The interface component 206 receives 808 a user selection of the marker (or corresponding label). The interface component 206 displays 810 the related image in response to receiving the user selection. In one embodiment, the method 800 may return to step 806 and display markers on the related image. For example, a user may be able to repeatedly select markers to traverse deeper into the hierarchical tree.

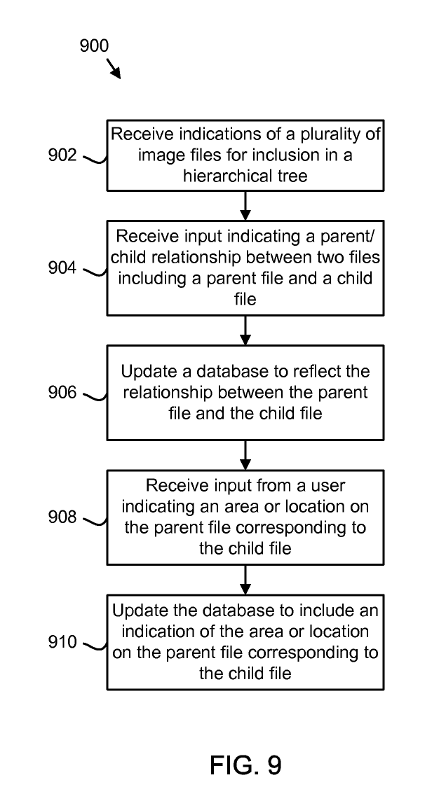

FIG. 9 illustrates a schematic flow chart diagram illustrating a method 900 for editing relationships between image or graphical files. In one embodiment, the method 900 is performed by the image management component 102 of FIG. 2. In one embodiment, the image management component 102 may require a user to authenticate before performing the method 900 or allowing the user to provide the input discussed below. For example, the user may authenticate by entering a user name and/or password corresponding to an account that has editing privileges.

The method 900 begins and the edit component 208 receives 902 indications of a plurality of files for inclusion in a hierarchical tree. In one embodiment, the edit component 208 receives the indications in response to a user selecting the thirteenth icon 710 on the relationship hierarchy view of FIG. 7. For example, the user may select the thirteenth icon 710 and then select one or more files for upload, inclusion, or tracking in a database. The edit component 208 may receive 902 the files or an indication or location of the files. The edit component 208 may also store the files or indications in a database for later access or reference.

The edit component 208 receives 904 input indicating a parent/child relationship between two files including a parent file and a child file. In one embodiment, the edit component 208 receives 904 input that includes dragging of the child file onto a node corresponding to the parent file in the hierarchical tree 702 shown in the relationship hierarchy view of FIG. 7. In one embodiment, the edit component receives 904 a user selection of a node corresponding to the parent file in the hierarchical tree 702, receives a selection of a file in the image list, and receives a selection of the add icon 712 to provide the indication that the file is a child of the parent file or node. The edit component 208 may receive 904 the indication of the relationship in any other manner as well. The edit component 208 may update 906 entries in a database to indicate that the parent file and child file have a relationship.

The edit component 208 receives 908 input from a user indicating an area or location on the parent file (or a displayed image corresponding a parent image or graphical file) corresponding to the child file. For example, a user may select a file and indicate a location on the parent file where a marker corresponding to the child file should be displayed. In one embodiment, the user may select a part or image name under an “Unassigned Sub-Parts” heading on the side bar 304 in FIG. 3 and then provide input on the image 308 to indicate where a marker corresponding to the image should be displayed. For example, the user may select the “Purification Station” part listed in the sidebar 304 and then click and/or drag (e.g., with a mouse), or tap and/or drag (e.g., on a touch screen), at a location corresponding to the Purification Station. The edit component 208 may receive 908 this as an indication of the location corresponding to the Purification Station image file. The edit component 208 may update 910 a database to include an indication of the area or location on the parent file corresponding to the child file. For example, the edit component 208 may update an entry corresponding to the parent file, the child file, or a relationship between the two to include one or more coordinates defining a location or area for a marker to be displayed on the parent file.

### EXAMPLES

The following examples pertain to further embodiments.

Example 1 is an image file management system for managing access to image files corresponding to physical facilities of a plant, factory, warehouse or other physical facility or set of facilities. The system includes an access component and an interface component. The access component is configured to access a database linking a plurality of images corresponding to the physical facilities in a hierarchical tree. The plurality of images include images corresponding to one or more root nodes, branch nodes, and leaf nodes of the hierarchical tree. The database further includes information indicating a location on a parent image corresponding to a child image. The interface component is configured to enable browsing of the plurality of images. The interface component is configured to display a first image corresponding to one or more of a root node and a branch node of the hierarchical tree. The interface component is configured to display one or more first image markers on the first image corresponding to one or more second images having a child relationship with the first image. The one or more markers are positioned on the first image corresponding to a location associated with the one or more second images. The interface component is configured to receive input from a user indicating selection of a first marker of the one or more first image markers. The interface component is configured to display an image (selected second image) from the one or more second images corresponding to the selected first marker in response to receiving the input indicating selection of the first marker.

In Example 2, the first image in Example 1 illustrates a physical object, physical system, or physical location in a graphical format. In Example 3, the first image in any of Examples 1-2 illustrates a layout one or more of a manufacturing facility campus, a packaging facility campus, a shipping or package routing facility campus, and a storage facility campus. In Example 4, the first image in any of Examples 1-2 illustrates a floor plan of a building or warehouse of one or more of a manufacturing facility, a packaging facility, a shipping facility, and a storage warehouse. In Example 5, the first image in any of Examples 1-2 illustrates a mechanical machine or mechanical system. In Example 6, the selected second image in any of Examples 1-5 illustrates a physical object or a physical system that is located in or part of the physical object, the physical system, or the physical location of the first image. In Example 7, the location of the first marker in Example 6 corresponds to a location of the physical object or the physical system of the selected second image in or on the first image. In Example 8, the selected second image in any of Examples 1-7 includes a CAD file or schematic illustrating a physical shape or configuration of a part or subsystem that is located in or part of the physical object, the physical system, or the physical location of the first image. In Example 9, the interface component in any of Examples 1-8 is configured to, in response to display of the selected second image, display one or more second image markers on the selected second image corresponding to one or more third images having a child relationship with the selected second image, receive input from a user indicating selection of a second marker of the one or more second image markers, and display an image (selected third image) from the one or more third images corresponding to the selected marker in response to receiving the user selection. The one or more second image markers are positioned on the selected second image corresponding to a location associated with the one or more third images.

Example 10 is a computer-implemented method for managing access to image files corresponding to physical facilities of a plant, factory, warehouse, or the like. The method includes accessing a database linking a plurality of images corresponding to the physical facilities in a hierarchical tree. The plurality of images include images corresponding to one or more root nodes, branch nodes, and leaf nodes of the hierarchical tree. The database further includes information indicating a location on a parent image corresponding to a child image. The method includes displaying a first image corresponding to one or more of a root node and a branch node of the hierarchical tree. The first image includes a graphical representation of a layout of a campus or a floor plan of the physical facilities. The method includes displaying one or more first image markers on the first image corresponding to one or more second images having a child relationship with the first image. The one or more first image markers are positioned on the first image corresponding to a location of one or more mechanical parts or mechanical systems corresponding to the one or more second images within the campus or floor plan of the first image. The method includes receiving input from a user indicating selection of a first marker of the one or more first image markers. The method includes displaying an image (selected second image) from the one or more second images corresponding to the selected first marker in response to receiving the input indicating selection of the first marker. The selected second image includes a graphical representation of a physical shape or configuration of a mechanical part or mechanical subsystem located within the physical facilities.

In Example 11, the method of Example 10 further includes displaying notes corresponding to a currently displayed image, wherein the notes include one or more of user comments, information regarding installation or repair procedures, a link to order a replacement part or system, a part number, and a manufacturer code. In Example 12, the method of any of Examples 10-11 further includes displaying an order label and initiating placement of an order for a part or subsystem illustrated by a current image in response to selection of the order label. In Example 13, the method of any of Examples 10-12 further includes displaying a relationship view, wherein the relationship view displays a tree structure with nodes corresponding to the plurality of images and relationships between the nodes indicating relationship links between the nodes. In Example 14, the method of any of Examples 10-13 further includes determining that a current user has edit rights. In Example 15, the method of any of Examples 10-14 includes receiving an indication of the plurality of images for hierarchical relationship tracking by the database, wherein the plurality of images each correspond to one or more of a floor plan of a facility, a layout of a campus of a facility, a mechanical system of the facility, a subsystem of the mechanical system of the facility, and a part of the mechanical system or subsystem of the facility. In Example 16, the method of any of Examples 10-15 further includes receiving input from a user indicating that an image of the plurality of images has a child relationship with another image of the plurality of images and updating the database to link the image with the other image in the child relationship.

In Example 17, the method of any of Examples 10-16 further includes displaying indications of one or more images having a child relationship to a currently displayed image. In Example 18, the indications of one or more images having a child relationship to a currently displayed image in Example 17 include an indication that a child image does not have a corresponding marker. In Example 19, the method of Example 18 further includes, in response to determining that a current user has edit rights, receiving input from the current user indicating a location on the currently displayed image that corresponds to the child image that does not have a corresponding marker. In Example 20, the method of Example 19 further includes updating the database to include the location on the currently displayed image corresponding to the child image and displaying a marker corresponding to the child image at the location on the currently displayed image.

Example 21 is one or more computer-readable storage media storing executable instructions that, when executed by one or more processors of a computer system, cause the computer system to perform a method for managing image files corresponding to physical facilities of a plant, factory, warehouse, or the like. The method includes accessing a database linking a plurality of images corresponding to the physical facilities in a hierarchical tree, wherein the plurality of images include images corresponding to one or more root nodes, branch nodes, and leaf nodes of the hierarchical tree, wherein the database further comprises information indicating a location on a parent image corresponding to a child image. The method includes displaying a first image corresponding to one or more of a root node and a branch node of the hierarchical tree, wherein the first image includes a graphical representation of a layout of a floor plan or a campus of the physical facilities. The method includes displaying one or more first image markers on the first image corresponding to one or more second images having a child relationship with the first image, wherein the one or more markers are positioned on the first image corresponding to a location associated with the one or more second images. The method includes receiving input from a user indicating selection of a first marker of the one or more first image markers. The method includes displaying an image (selected second image) from the one or more second images corresponding to the selected first marker in response to receiving the input indicating selection of the first marker, wherein the selected second image includes a graphical representation a mechanical system at a location of the selected first marker within the floor plan or the campus of the physical facilities. The method includes displaying one or more second image markers on the selected second image corresponding to one or more third images having a child relationship with the selected second image, wherein the one or more second image markers are positioned on the selected second image corresponding to a location associated with the one or more third images. The method includes receiving input from a user indicating selection of a second marker of the one or more second image markers. The method includes displaying an image (selected third image) from the one or more third images corresponding to the selected marker in response to receiving the user selection, wherein the selected third image includes a graphical representation of a mechanical subsystem or mechanical part at a location of the selected second marker within the mechanical system of the selected second image.

Some of the components that can be used with embodiments disclosed herein are already available, such as general-purpose computers, mobile phones, computer programming tools and techniques, digital storage media, and communications networks. A computing device may include a processor such as a microprocessor, a microcontroller, a logic circuitry, or the like. The processor may include a special-purpose processing device such as an ASIC, a PAL, a PLA, a PLD, an FPGA, or another customized or programmable device. The computing device may also include a computer-readable storage device such as non-volatile memory, static RAM, dynamic RAM, ROM, CD-ROM, disk, tape, magnetic memory, optical memory, flash memory, or another computer-readable storage medium.

Various aspects of certain embodiments may be implemented using hardware, software, firmware, or a combination thereof. As used herein, a software module may include any type of computer instruction or computer executable code located within or on a non-transitory computer-readable storage medium. A software module may, for instance, comprise one or more physical or logical blocks of computer instructions, which may be organized as a routine, a program, an object, a component, a data structure, etc., that performs one or more tasks or implements particular abstract data types.

In certain embodiments, a particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media. Some embodiments may be practiced in a distributed computing environment where tasks are performed by a remote processing device linked through a communications network.

The systems and methods disclosed herein are not inherently related to any particular computer or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, a component, a subroutine, or another unit suitable for use in a computing environment. Further, a computer program can be deployed to be executed on one computer or on multiple computers at one site or distributed across multiple sites and interconnected by a communication network. Software embodiments may be implemented as a computer program product that comprises a non-transitory storage medium configured to store computer programs and instructions that, when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, a digital-video disk, a magnetic tape, a Bernoulli drive, a magnetic disk, a punch card, flash memory, integrated circuits, or any other non-transitory digital processing apparatus memory device.

One of ordinary skill in the art will appreciate that various modifications and changes can be made without departing from the scope of the present disclosure. For example, various operational steps, as well as components for carrying out operational steps, may be implemented in alternative ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

It will be obvious to those having skill in the art that many changes may be made to the details of the above-described embodiments without departing from the underlying principles of the invention. The scope of the present invention should, therefore, be determined only by the following claims.

1. An image file management system for managing access to image files corresponding to physical facilities of a plant, factory or warehouse, the system comprising:
an access component configured to access a database linking a plurality of images corresponding to the physical facilities in a hierarchical tree, wherein the plurality of images comprise images corresponding to one or more root nodes, branch nodes, and leaf nodes of the hierarchical tree, wherein the database further comprises information indicating a location on a parent image corresponding to a child image; and
an interface component configured to enable browsing of the plurality of images, wherein the interface component is configured to
display a first image corresponding to one or more of a root node and a branch node of the hierarchical tree,
display one or more first image markers on the first image corresponding to one or more second images having a child relationship with the first image, wherein the one or more markers are positioned on the first image corresponding to one or more locations associated with the one or more second images,
receive input from a user indicating selection of a first marker of the one or more first image markers, and
display an image (selected second image) from the one or more second images corresponding to the selected first marker in response to receiving the input indicating selection of the first marker.

2. The system of claim 1, wherein the first image illustrates a physical object, a physical system, or a physical location in a graphical format.

3. The system of claim 2, wherein the first image illustrates a layout of a campus of one or more of a manufacturing facility, a packaging facility, a shipping or package routing facility, and a storage facility.

4. The system of claim 2, wherein the first image illustrates a floor plan of a building or warehouse of one or more of a manufacturing facility, a packaging facility, a shipping facility, and a storage warehouse.

5. The system of claim 2, wherein the first image illustrates a mechanical machine or mechanical system.

6. The system of claim 2, wherein the selected second image illustrates a physical object or a physical system that is located in or part of the physical object, the physical system, or the physical location of the first image.

7. The system of claim 6, wherein a location of the first marker corresponds to a location of the physical object or the physical system of the selected second image in or on the first image.

8. The system of claim 2, wherein the selected second image comprises a computer-aided design (CAD) file or schematic illustrating a physical shape or configuration of a part or subsystem that is located in or part of the physical object, the physical system, or the physical location of the first image.

9. The system of claim 1, wherein, in response to display of the selected second image, the interface component is further configured to:
display one or more second image markers on the selected second image corresponding to one or more third images having a child relationship with the selected second image, wherein the one or more second image markers are positioned on the selected second image corresponding to one or more locations location associated with the one or more third images;
receive input from a user indicating selection of a second marker of the one or more second image markers; and
display an image (selected third image) from the one or more third images corresponding to the selected second marker in response to receiving the user selection.

10. A computer-implemented method for managing access to image files corresponding to physical facilities of a plant, factory or warehouse, the method comprising:
accessing a database linking a plurality of images corresponding to the physical facilities in a hierarchical tree, wherein the plurality of images comprise images corresponding to one or more root nodes, branch nodes, and leaf nodes of the hierarchical tree, wherein the database further comprises information indicating a location on a parent image corresponding to a child image;
displaying a first image corresponding to one or more of a root node and a branch node of the hierarchical tree, wherein the first image comprises a graphical representation of a layout of a campus or a floor plan of the physical facilities;
displaying one or more first image markers on the first image corresponding to one or more second images having a child relationship with the first image, wherein the one or more first image markers are positioned on the first image corresponding to one or more locations of one or more mechanical parts or mechanical systems corresponding to the one or more second images within the campus or floor plan of the first image;
receiving input from a user indicating selection of a first marker of the one or more first image markers; and
displaying an image (selected second image) from the one or more second images corresponding to the selected first marker in response to receiving the input indicating selection of the first marker, wherein the selected second image comprises a graphical representation of a physical shape or configuration of a mechanical part or mechanical subsystem located within the physical facilities.

11. The computer-implemented method of claim 10, further comprising displaying notes corresponding to a currently displayed image, wherein the notes comprise one or more of user comments, information regarding installation or repair procedures, a link to order a replacement part or system, a part number, and a manufacturer code.

12. The computer-implemented method of claim 10, further comprising displaying an order label and initiating placement of an order for a part or subsystem illustrated by a current image in response to selection of the order label.

13. The computer-implemented method of claim 10, further comprising displaying a relationship view, wherein the relationship view displays a tree structure with nodes corresponding to the plurality of images and relationships between the nodes indicating relationship links between the nodes.

14. The computer-implemented method of claim 13, further comprising determining that a current user has edit rights.

15. The computer-implemented method of claim 14, further comprising, receiving an indication of the plurality of images for hierarchical relationship tracking by the database, wherein the plurality of images each correspond to one or more of a floor plan of a facility, a layout of a campus of the facility, a mechanical system of the facility, a subsystem of the mechanical system of the facility, and a part of the mechanical system or subsystem of the facility.

16. The computer-implemented method of claim 14, further comprising:
receiving input from a user indicating that an image of the plurality of images has a child relationship with another image of the plurality of images; and
updating the database to link the image with the other image in the child relationship.

17. The computer-implemented method of claim 10, further comprising displaying indications of one or more images having a child relationship to a currently displayed image.

18. The computer-implemented method of claim 17, wherein the indications of one or more images having a child relationship to a currently displayed image comprise an indication that a child image does not have a corresponding marker.

19. The computer-implemented method of claim 18, further comprising in response to determining that a current user has edit rights, receiving input from the current user indicating a location on the currently displayed image that corresponds to the child image that does not have a corresponding marker.

20. The computer-implemented method of claim 19, further comprising updating the database to include the location on the currently displayed image corresponding to the child image and displaying a marker corresponding to the child image at the location on the currently displayed image.

21. One or more computer-readable storage media storing executable instructions that, when executed by one or more processors of a computer system, cause the computer system to perform a method for managing image files corresponding to physical facilities of a plant, factory or warehouse, the method comprising:
accessing a database linking a plurality of images corresponding to the physical facilities in a hierarchical tree, wherein the plurality of images comprise images corresponding to one or more root nodes, branch nodes, and leaf nodes of the hierarchical tree, wherein the database further comprises information indicating a location on a parent image corresponding to a child image;
displaying a first image corresponding to one or more of a root node and a branch node of the hierarchical tree, wherein the first image comprises a graphical representation of a layout of a floor plan or a campus of the physical facilities;
displaying one or more first image markers on the first image corresponding to one or more second images having a child relationship with the first image, wherein the one or more markers are positioned on the first image corresponding to one or more locations associated with the one or more second images;
receiving input from a user indicating selection of a first marker of the one or more first image markers;
displaying an image (selected second image) from the one or more second images corresponding to the selected first marker in response to receiving the input indicating selection of the first marker, wherein the selected second image comprises a graphical representation a mechanical system at a location of the selected first marker within the floor plan or the campus of the physical facilities;
displaying one or more second image markers on the selected second image corresponding to one or more third images having a child relationship with the selected second image, wherein the one or more second image markers are positioned on the selected second image corresponding to one or more locations associated with the one or more third images;
receiving input from a user indicating selection of a second marker of the one or more second image markers; and
displaying an image (selected third image) from the one or more third images corresponding to the selected second marker in response to receiving the user selection, wherein the selected third image comprises a graphical representation of a mechanical subsystem or mechanical part at a location of the selected second marker within the mechanical system of the selected second image.
